(19) United States
(12) Patent Application Publication
(10) Pub. No.: US 2023/0399758 A1
(43) Pub. Date: Dec. 14, 2023

(54) HYDROGEN-EVOLVING ELECTRODES, MEMBRANE ELECTRODE ASSEMBLIES AND ELECTROLYZERS BASED THEREON AND METHODS OF FABRICATION THEREOF

(71) Applicant: Advent Technologies Holdings, Inc., Boston, MA (US)

(72) Inventors: Ian Kendrick, Salem, MA (US); Ryan Pavlicek, Roslindale, MA (US); Emory Sayre De Castro, Nahant, MA (US)

(21) Appl. No.: 18/323,886

(22) Filed: May 25, 2023

Related U.S. Application Data
(60) Provisional application No. 63/345,882, filed on May 25, 2022.

(51) Int. Cl. C25B 11/032; C25B 11/052; C25B 11/065

(52) U.S. Cl. CPC C25B 11/032; C25B 11/052; C25B 11/065

(57) ABSTRACT

Aspects of the invention provide novel cathodes to be employed with membranes that can operate in ionomer membrane-based electrolyzer cells between at least 50- and 95-degrees C. The cathodes comprise a carbon-based substrate, e.g., of woven cloth or paper, a hydrophobic binder-containing microporous layer, e.g., polytetrafluoroethylene (PTFE), and a catalyst layer comprising electrocatalysts and binders demonstrating ionic conductivity over a range of dry and wet operating conditions. According to some aspects of the invention, at least one layer of the microporous layer or catalyst layer has defined pore structure.

### REFERENCE TO RELATED APPLICATIONS

This application claims the benefit of priority of U.S. Patent Application Ser. No. 63/345,882, filed May 25, 2022, and entitled HYDROGEN EVOLVING ELECTRODES, MEMBRANE ELECTRODE ASSEMBLIES AND ELECTROLYZERS BASED THEREON AND METHODS OF FABRICATION THEREOF, the teachings of which are incorporated herein by reference.

### STATEMENT REGARDING FEDERALLY SPONSORED RESEARCH OR DEVELOPMENT

This invention was made with government support under Grant DE-EE0008082, awarded by the Department of Energy. The government has certain rights in the invention.

### DESCRIPTION OF THE RELATED ART

The present invention relates to hydrogen-evolving electrodes and membrane electrode assemblies. The invention has application, for example, in ionomer membrane-based electrolyzer cells operating at greater than about 50° C.

Hydrogen production via electrolysis is a process where a current is applied to an aqueous electrolyte solution and the water is split into its oxygen and hydrogen components. Electrolysis is a mature technology that has its origins in the late 1800s and uses liquid alkaline electrolytes. The introduction of proton-exchange membranes (PEMs), including Chemours 'Nafion® in the 1960's allowed for ionomer membrane-based electrolyzers that were more compact and scalable, while the hydrogen evolved was easier to pressurize. The main drawback to PEM-based electrolyzers is that the cost of the noble-metal anodic oxygen evolution reaction (OER) and cathodic hydrogen evolution reaction (HER) catalysts are too high for widespread adoption. The relatively recent introduction of anion exchange membranes (AEMs) allows for cheaper and more abundant metals to be used in electrochemical reactors that would otherwise corrode at higher pHs.

In either of these cases, high-performance materials and refined electrode architectures are required to allow these reactors to operate at higher current densities within reasonable operating potentials. Catalysts must have adequate concentrations of reactants to satisfy the stoichiometric requirements of operating at specific current densities. In the case of PEM electrolyzers, the catalyst requires solvated hydronium ions to be reduced to hydrogen gas. AEM electrolyzers reduce water molecules that are either pumped to the catalyst or diffuse across the anion-exchange membrane from the anode. Conversely, catalysts and electrodes must also be able to clear the electrocatalytically inert products of these reactions to make room for more reactants.

Objects of the invention are to provide improved electrodes and, particularly, cathodes to promote hydrogen evolution reactions.

Related objects are to provide membrane electrode assemblies and electrolyzers that utilize such electrodes.

Still further related objects of the invention are to provide such electrodes, membrane electrode assemblies and electrolyzers that operate at greater than about 50° C.

### SUMMARY OF THE INVENTION

The foregoing objects are among those achieved by the invention, aspects of which provide novel electrodes for use with membranes that can operate in liquid-fed ionomer membrane-based electrolyzer cells between at least about 50 and about 95 degrees C. and between 0 and 100% relative humidity. The electrodes can be used in electrochemical cells running in acidic (pH<4) or alkaline (pH>9) environments.

Such electrodes and, particularly, cathodes, can, according to some aspects of the invention, comprise a carbon-based substrate, e.g., of woven cloth or paper, a hydrophobic binder-containing microporous layer, e.g., of polytetrafluoroethylene (PTFE), and a catalyst layer comprising electrocatalysts and binders demonstrating ionic conductivity over a range of dry and wet operating conditions. Such cathodes have a pore structure of between 0.4 μm to 50 μm and, according to related aspects of the invention, of between 0.4 μm and 13 μm.

Related aspects of the invention provide electrodes, e.g., as described above, in which at least one of the microporous layer and the catalyst layer has a defined pore structure and particle size distribution, respectively, that are optimized to minimize the diffusion of water from the catalyst surface and to allow for the efficient clearing of hydrogen gas from the catalyst, thereby, enhancing electrode performance during hydrolysis. More particularly, for example, according to some aspects of the invention, the microporous layer has a pore structure of between 0.4 μm and 50 μm and, according to related aspects of the invention, of between 0.4 μm and 13 μm.

Further aspects of the invention provide membrane electrode assemblies, e.g., with cathodes of the type described above.

Still further aspects of the invention provide electrolyzer cells, e.g., with membrane electrode assemblies and one or more electrodes of the type described above.

Yet still further aspects of the invention provide methods of fabricating cathodes of the types described above.

### BRIEF DESCRIPTION OF THE DRAWING

A more complete understanding of the invention may be attained by reference to the drawings, in which:

FIG. 1 depicts an ionomer membrane-based electrolyzer cell according to one practice of the invention containing membrane electrode assemblies of the type including cathodes according to one practice of the invention;

FIG. 2 depicts specifically a membrane electrode assembly according to one practice of the invention including a cathode according to one practice of the invention; and

FIG. 3 depicts a process of fabricating a cathode according to the invention.

### DETAILED DESCRIPTION OF THE ILLUSTRATED EMBODIMENT

Described below are novel electrodes, membrane electrode assemblies and ionomer membrane-based electrolyzers. These capitalize, in some embodiments of the invention, on novel combinations of electrode microporous layer porosity (or pore structure) and catalyst layer porosity profiles, as well in some embodiments on solvent mixes, to promote hydrogen evolution reactions by minimizing the diffusion of water from the catalyst surface and allowing for efficient clearing of hydrogen gas from the catalyst. As used in this application, the terms “porosity” and “pore structure” are used interchangeably to refer to the mean size (or range of mean sizes) of diameters of pores distributed (as a result a mixing and/or other processes) over and through a volume of a material.

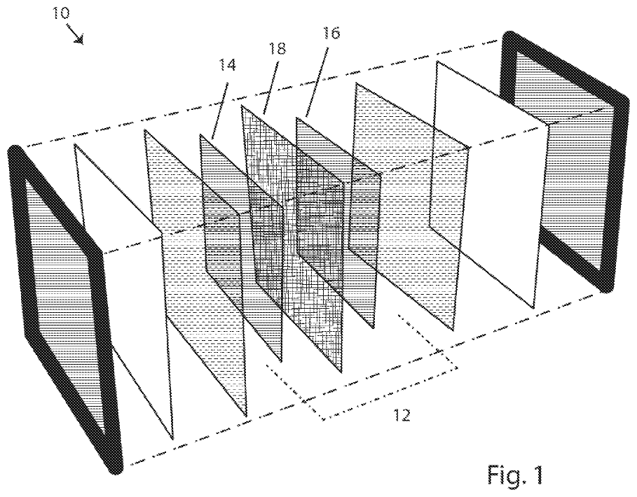

Referring to FIG. 1, there is shown an ionomer membrane-based electrolyzer cell 10 according to the invention. The cell includes membrane electrode assembly (MEA) 12 according to the invention, which includes gas diffusion electrodes, namely, anode 14 and cathode 16, the latter of which is constructed according to the invention. The ionomer membrane-based electrolyzer cell 10 is of the conventional type known in the art as adapted in accord with the teachings hereof. The MEA 12 includes an ion-conductive membrane 18 per convention in the art as adapted in accord with the teachings hereof. The MEA 12 and cell 10 may include other componentry (e.g., gas diffusion layers, gaskets, and so forth), again, per convention in the art as adapted in accord with the teachings hereof

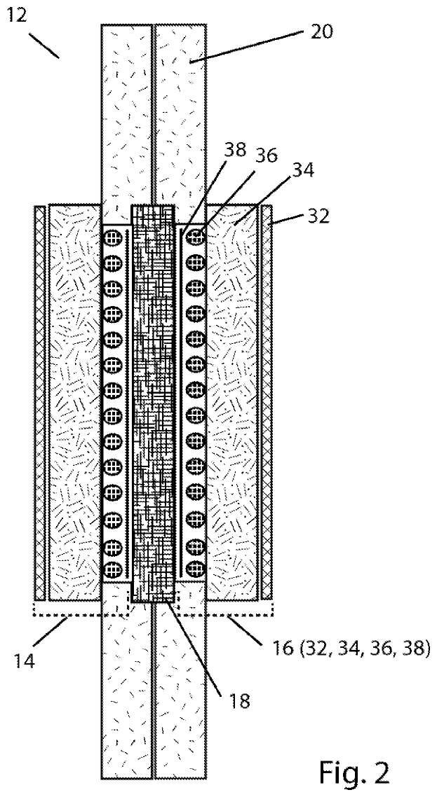

FIG. 2 depicts further details of the membrane electrode assembly 12, including, ion-conductive membrane 18, inner gasket 20 (both per convention in the art as adapted in accord with the teachings hereof) and a gas diffusion cathode 16 in accord with the invention. Further details of the construction of that cathode 16 are provided below and discussed elsewhere herein. In the illustrated embodiment, anode 14 is a conventional gas diffusion anode of the type known in the art.

With continued reference to FIG. 2, illustrated gas diffusion cathode 16 includes a carbon substrate or support layer 32, a carbon & hydrophobic binder-containing microporous layer 34 such as PTFE, and a catalyst layer 36 that additionally contains ionomeric binders. A thin topcoat 38 of ionomer may also be provided to improve interfacial characteristics with the ion conducting membrane per convention in the art as adapted in accord with the teachings herein.

The role of the support layer 32 is to provide an ion-permeable substrate upon which the other, active layers of the electrode 16 are deposited. Though in some embodiments metallic support layers are used, in the illustrated embodiment the support layer comprises carbon. Carbon support materials for layer 32 of the illustrated embodiment have thicknesses less than 400 μm (and, more particularly, preferably of between 20 μm and 50 μm) and are of high inherent hydrophobicity, high conductivity, alkaline stability, and a well-defined pore distribution. Materials with a preferred combinations of those parameters (e.g., as characterized by methods including but not limited to Scanning Electron Microscopy, Cobb titrations and contact angle measurements, electrical conductivity tests, alkaline stability, and Capillary Flow Porometry, though it will be appreciated that the invention can be practiced with materials having other combinations of these and other parameters.

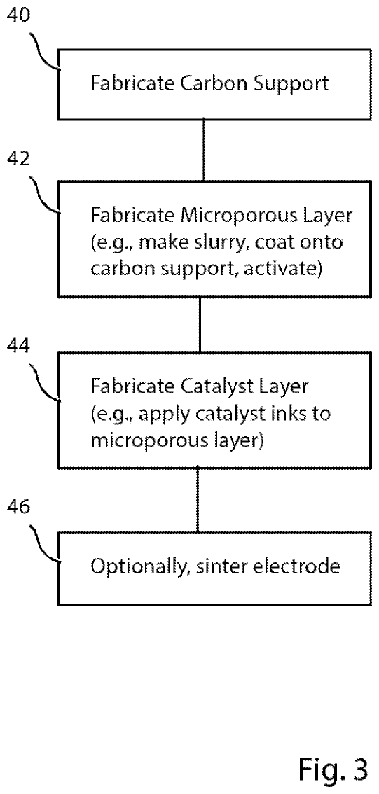

Suitable such substrates 32 can include carbon or graphite-based woven cloths or papers such as those commercially available from AvCarb of AvCarb, Lowell, Massachusetts; SGL Carbon of Germany (under their Sigracet Fuel Cell Component line); and Freudenberg of Germany. The support layer 32 can be fabricated or fashioned from such materials per convention in the art as adapted in accord with the teachings hereof. See, FIG. 3, step 40.

The role of a microporous layer 34 is to provide an optimized pore structure to facilitate both water transport to the catalytic active sites as well as gas away from the active sites, which can otherwise inhibit mass transport within the ionomer membrane-based electrolyzer cell.

Microporous layer 34 of the illustrated embodiment comprises a carbon and a hydrophobic binder, and is fabricated using formulations and processes of the type known in the art for membrane electrode assembly (MEA) gas diffusion layers (GDLs) based on carbon black and a hydrophobic agent such as PTFE; see, for example, X. L. Wang et al Micro-porous layer with composite carbon black for PEM fuel cells Electrochimica Acta 51 (2006) 4909-4915, the teachings of which are incorporated herein by reference. Illustrated microporous layer 34 is fabricated as discussed below and is additionally characterized by having
bubble points determined by Capillary Flow Porometry (CFP) of less than 20 μm when a carbon or graphite paper is used, and less than 50 μm when a carbon or graphite weave is used.
a pore structure characterized by mean pore (diameter) sizes of less than 3 μm when a carbon or graphite paper is used, and less than 10 μm when a carbon or graphite weave is used, as determined by Capillary Flow Porometry (CFP).
The thickness of the microporous layer 34 is between 20 μm and 50 μm, and the overall combined thickness of the carbon cloth support layer 32 and the microporous layer 34 is between 200 μm and 500 μm following any drying and sintering steps as determined by Scanning Electron Microscopy (SEM).

With reference to FIG. 3, step 42, in the illustrated embodiment, the microporous layer is fabricated by applying a slurry made from such an aforesaid formulation to the carbon substrate 32 in a process that can either be a single coat or multi-coat, with the microporous layer being dried after each coat. Microporous layer 34 of other embodiments may comprise other formulations, whether based on carbon and a hydrophobic binder or otherwise. Examples include carbon blacks from Cabot Carbon (e.g. Vulcan XC72), acetylene blacks, or modified carbon blacks from Pajarito Powder LLC, New Mexico. In some embodiments, oven activation of the microporous layer 34 is done following completed deposition of the MPL 34. The desired pore structure/porosity can be achieved, by way of non-limiting example, by a combination of blending speed and/or time, or otherwise, all as is within the ken of those skilled in the art as adapted in accord with the teachings hereof. Significantly, the porosity of the layer 34 is adapted so that, in combination with the substrate 32, the combined porosity is preferably between 0.4 μm and 50 μm and, still more preferably, between 0.4 μm and 13 μm. Further adaptation of the formulation and/or application of the slurry to the substrate 32 to achieve the desired bubble point sizing and MPL thickness is within the ken of those skilled in the art in view of the teachings hereof.

The role of the catalyst layer 36 of electrode 16 is to enable chemical reactions that, on the cathode side, reduce water to yield hydrogen gas and hydroxide, and, on the anode side, oxidize those hydroxide ions to produce water and oxygen. In the illustrated embodiment, layer 36 is fabricated from mixed aqueous/organic catalyst inks that are formulated from a carbon-supported catalyst, which can be metallic or non-metallic, and one or more ionomeric binders. The metal can be, by way of non-limiting example, platinum. The ionomeric binders can include any of polystyrene, polyphenyl or can be polyfluorene-based, all by way of non-limiting example, additions to and alternatives to which are within the ken of those skilled in the art in view of the teachings hereof. The base solvent is a combination of, but not necessarily solely comprising, water, 1-propanol, 2-propanol, NMP, DMAC, DMSO, DMF, and cyclopentanone. Mixing is done through a combination of high-shear and non-shear mixing to achieve desired particle size distribution. Catalyst layer 36 of the illustrated embodiment have the following characteristics:
Catalyst loading of between 2 mg/cm² and 12.5 mg/cm² (total loading or metal loading based on catalysts), as determined gravimetrically or by X-Ray Fluorescence (XRF)
The catalyst layer having bubble points determined by Capillary Flow Porometry less than when a carbon or graphite paper is used, and less than 70 μm when a carbon or graphite weave is used.
Mean pore diameter sizes should be less than 20 μm for both carbon and graphite papers and weaves.
Catalyst by weight in the range of 20%-90%, and more particularly 70%-90% in the dried catalyst layer, with all binders in the range of 10%-30%
Catalyst layer thickness of between 0.40 mm and 1.20 mm, as determined by Scanning Electron Microscopy (SEM)

Referring to FIG. 3, step 44, to form the layer 36, the catalyst inks are applied to the previously applied microporous layer 34 in a process that can either be a single coat or multi-coat, with the catalyst layer being dried after each coat. Catalyst layer 36 of other embodiments may comprise other formulations, such as, for example, metallic catalyst that are un-supported (lacking carbon support), catalysts on non-carbon-based support materials, such as metallic supports or oxide materials such as Silicon Dioxide. To achieve the desired porosity, the inks are sheared between 2000 and 8000 rpms for to 90 minutes. Significantly, the inks are adapted so that, in combination with other components of the electrode (e.g., substrate 32 and MPL 34), the combined pore structure pores is between 0.4 μm and and, still more preferably, between 0.4 μm and 13 μm. Further adaptation of the formulation and/or application of the inks to the MPL to achieve the desired loading, bubble point sizing and thickness is within the ken of those skilled in the art in view of the teachings hereof.

In some embodiments, electrodes 16 according to the present invention can be processed with a sintering step above 300° C., e.g., of the type known in the art for use in fabrication of ionomer membrane-based electrolyzer electrodes, though this is not a requirement of the invention. See Step 46.

In electrodes 16 according to the invention, porosity of both the substrate 32 with microporous layer 34 as well as the complete electrode 36, is determined, e.g., via capillary flow porometry. Moreover, packing of the catalyst layer 36 onto the microporous layer 34 is preferably achieved by a combination of controlling the hydrophobicity of the MPL as well as the solvent mix in the catalyst ink to limit catalyst falling into the pores of the microporous layer, therefore reducing electrode activity through inaccessible active sites. Confirmation is acquired through Scanning Electron Microscopic analysis of the interface of the catalyst layer and microporous layer.

Further characteristics and parameters of preferred electrodes 16 according to the invention are set forth below. Achieving such characteristics and parameters is within the ken of those skilled in the art in view of the teachings hereof:
Operation from 50° C. to 95° C., including long lifetime across that entire range, as determined by electrolyzer cell performance & durability studies
Operation under a wide range of humidity from 0-100% relative humidity (RH)
Operation with a liquid fed to either or both of the electrodes
Electrodes have been developed for use in alkaline environments but can be used in acidic environments as well
Electrodes show improved performance cathode electrodes without the MPL and sheared electrode inks
The cathode catalyst layer having an optimized pore structure for operation between 50° C. and 95° C.
The cathode microporous layer having an optimized pore structure that is optimized for performance between 50° C. and 95° C. in the presence of hydrogen or hydrogen containing water vapor.

A more complete understanding of practice of the invention may be attained through study of the examples below.

### EXAMPLES

Example 1—Microporous Layer Fabrication: A woven or paper cloth or graphite material is chosen for coating. The microporous layer ink is prepared by mixing the desired carbon, for example, Soltex Acetylene Black or Vulcan XC-72, with water. Other surfactants can be added to the mix as well, as is within the ken of those skilled in the art in view of the teachings hereof. A series of inks, namely, for example, polyethylene glycol and alkyne diol, with high-shear mixing between 15 and 90 minutes are prepared. A fluorinated hydrocarbon, for example PTFE, is added and the mixture is mixed on a non-shear mixer for 15 to 60 minutes. Other additives such as thickeners or surfactants the use of which is within the ken of those skilled in the art may be used to improve the ability to coat. The mixture is applied to the chosen web, with the web being air-dried in between each coat, until the desired loading is achieved (3 to 50 g/m²). Following completion of coating, the material is heat-treated to 340° C. for between 15 and minutes. This completes the gas diffusion layer (GDL), or microporous layer (MPL)

Example 2—Cathode Fabrication: An already-prepared MPL (such as that prepared in Example 1) is used as a substrate. Catalyst inks are prepared using an aqueous/organic mixture, for example water and 1-propoanol. This mixture contains solvent, catalyst, for example a Platinum or PGM-free metal supported on XC-72, KB-300, or KJ-600, and an ionomer such as Fumion (Fumatech), PiperION-A (Versogen), or Orion CM (Orion). A series of inks is prepared for evaluation using different high-shear mixing times, from 15 to minutes. Following addition of the polymer and/or ionomer, the mixture can be mixed via a non-shear methodology for anywhere from 15 minutes to 16 hours. The ink is applied to one side of the prepared MPL in multiple coats, until the catalyst loading is at the desired loading, which can be from 2.0 mg/cm² to 12.5 mg/cm² (either metal or total catalyst depending on catalyst selection). The web and catalyst layer are air-dried in between each layer. A series of electrodes are prepared at different catalyst loadings for evaluation.

Example 3—MPL and GDL Characterization: Catalyst layer thickness is evaluated using cross-section image analysis on a scanning electron microscope (SEM). Cross-section sample preparation and analysis is well-documented. Bubble point and mean pore (diameter) size are evaluated using capillary flow porometry, whereby an increasing pressure of inert gas is used to remove a wetting agent that is introduced to the pores of the electrode. As the pressure is increased, wetting agent is removed from smaller pores. This evaluation is done on the base substrate, the completed microporous layer (before or after sintering), and the completed electrode including catalyst layer.

Example 4—Ionomer membrane-based electrolyzer cell Testing: employs 5 cm² to 47 cm² active area single cells and traditional graphite fields. Testing is done with a liquid electrolyte solution delivered to the anode, and in some cases, to the cathode as well.

Described above are novel cathodes, membrane electrode assemblies and ionomer membrane-based electrolyzer cells, as well as methods of fabrication thereof, according to the invention. It will be appreciated that the embodiments discussed above and shown in the drawings are examples of the invention and that other embodiments incorporating changes to those shown here also fall within the scope of the invention.

In view of the foregoing, what we claim is:

1. A gas diffusion cathode comprising a supported layer, a microporous layer disposed on the support layer and a catalyst layer disposed on the support layer, where the catalyst layer comprises a catalyst and an ionomeric binder.

2. The gas diffusion cathode of claim 1 for cathodic electrolyzer cell reactions with a bubble point between 20 and 70 microns.

3. The gas diffusion cathode of claim 1 for cathodic electrolyzer cell reactions with a mean pore diameter between 0.4 μm and 50 μm.

4. The gas diffusion cathode of claim 3, with a mean pore diameter of between 0.4 μm and 13 μm.

5. The gas diffusion cathode of claim 1, wherein the catalyst layer is formed by a method of preparing an ink containing one or more carbon-supported precious metal catalysts with a solvent that is a combination of water and one or more of 1-propanol, iso-propanol, NMP, DMAC, DMSO, DMF, and cyclopentanone.

6. A membrane electrode assembly comprising a gas diffusion cathode according to any of claims 1-5.

7. A gas diffusion cathode comprising
A. a carbon substrate layer,
B. microporous layer disposed on the carbon substrate layer, the microporous layer comprising a carbon and a hydrophobic binder, and
C. a catalyst layer disposed on the microporous layer.

8. The gas diffusion cathode of claim 7, where the hydrophobic binder comprises PTFE.

9. The gas diffusion cathode of claim 7, wherein the catalyst layer additionally comprises an ionomeric binder.

10. The gas diffusion cathode of claim 9, wherein the ionomeric binder comprises proton exchange ionomer.

11. The gas diffusion cathode of claim 9, wherein the catalyst layer comprises a hydrogen exchange ionomer.

12. The gas diffusion cathode of claim 7, comprising a topcoat layer disposed on the catalyst layer, where the topcoat layer comprises at least one of an ionomer.

13. The gas diffusion cathode of claim 7 wherein the microporous layer has a pore diameter between and 50 μm.

14. The gas diffusion cathode of claim 7 wherein the microporous layer has a pore diameter between and 13 μm.

15. A membrane cathode assembly including a gas diffusion electrode according to any of claims 7-12.

16. An electrolyzer cell comprising a membrane electrode assembly according to any of claims 6 and 13.
